(19) United States
(12) Patent Application Publication
(10) Pub. No.: US 2009/0155605 A1
(43) Pub. Date: Jun. 18, 2009

(54) HYDROPHILIC MIRROR COATED TIO2 MEMBRANE ON CHROME PLATE AND MANUFACTURING PROCESS THEREOF

(76) Inventors: Ki-sun Lee, Gyeonggi-do (KR); Sang-hoon Lee, Chungcheongnam-do (KR)

Correspondence Address: NIXON & VANDERHYE, PC, 901 NORTH GLEBE ROAD, 11TH FLOOR, ARLINGTON, VA, 22203, US

(21) Appl. No.: 12/094,826

(22) PCT Filed: Jan. 10, 2007
(86) PCT No.: PCT/KR2007/000178

§ 371 Date: Oct. 23, 2008

(30) Foreign Application Priority Data
Nov. 9, 2006 (KR) 10-2006-0110309

(51) Int. Cl. B01J 21/06; B32B 15/04; B32B 17/06

(52) U.S. Cl. 428/432; 428/472

(57) ABSTRACT

The present invention relates to a hydrophilic photocatalyst and a process of preparation thereof to obtain a titanium dioxide (TiO2) layer of an anatase structure having an excellent photocatalystic effect on a chromium substrate, and in particular to a hydrophilic photocatalyst and a process for preparation thereof including: coating a titanium dioxide (TiO2) layer of an amorphous form on the substrate while maintaining the temperature of the substrate below 200° C., coating the TiO2 layer of a pure anatase structure on the TiO2 layer of the amorphous form, and coating a silicon dioxide layer on the TiO2 layer of the pure anatase structure, wherein a super-hydrophilic property having a contact angle below 10 degrees showing a photocatalystic effect by ultraviolet irradiation appears within 1 hour after UV irradiation and a hydrophilic property having a contact angle below 20 degrees between the substrate and water drops is maintained for 18 hours.

### TECHNICAL FIELD

The present invention relates to a hydrophilic mirror having an anatase titanium dioxide (TiO₂) layer, which has an improved photocatalystic function, formed on a chromium substrate, and a process for preparation method thereof, and in particular, to a photocatalyst mirror that reduces reflectivity and improves a hydrophilic property.

### BACKGROUND ART

Generally, titanium dioxide (TiO₂) having photocatalytic property is available in different crystallized forms including anatase, rutile or brookite.

Among them, the anatase (3.2 eV) and rutile (3.0 eV) TiO₂ have hydrophilic effects by photoexcitation, and the anatase structure is better in photoactivity than the rutile structure, because the band gap of the anatase TiO₂ is greater than that of the rutile TiO₂.

To show a hydrophilic property, anatase TiO₂ should be irradiated with short wavelength ultraviolet rays, and to maintain the hydrophilic property at night, it is preferred to delay the recombination of electrons and holes generated during the photoexcitation.

A side mirror of an automobile is one of components having the photocatalystic property, and a blue mirror is advantageous as a side mirror, because the peak sensibility of human eyes tends to be shifted towards blue as it gets darker and the blue mirror provides good visibility at night.

A conventional method for manufacturing a hydrophilic mirror using the photocatalystic effect of TiO₂, as suggested in Korean Patent No. 10-7004587, uses glass as a substrate, and in the case that ultraviolet irradiation is performed on a glass substrate, the hydrophilic mirror has a super-hydrophilic property having a contact angle below 10 degrees between the substrate and water, whereas in the case that ultraviolet rays are blocked, the hydrophilic mirror loses the super-hydrophilic property.

Another conventional method for manufacturing a blue hydrophilic mirror, as suggested in Korean Patent No. 10-0397252, which is an improved technology based on the above prior art, is not simply coated with a TiO₂ layer on a glass substrate as in the above prior art, but is formed with a layer made of materials including SiO₂, Al₂O₃, SnO₂ and MgF₂ on a chromium plated layer having good reflectivity to control the reflectivity and is further coated with a TiO₂ layer thereon.

To effectively utilize the hydrophilic mirror, the hydrophilic mirror should maintain the hydrophilic property at night when ultraviolet rays are blocked as described above, and to maintain the hydrophilic property at night, the prior art has suggested to form an SiO₂ layer having an excellent water adsorption property on the uppermost layer of a substrate, and thus water molecules adsorbed to the SiO₂ layer are combined with hydroxyl radicals (OH⁻) generated on the surface of TiO₂ by ultraviolet irradiation in the daytime and serves to maintain the hydrophilic property for a long period, and a structure of a mirror according to the prior art is shown in FIG. 1.

As shown in FIG. 1, a conventional mirror of an automobile includes a substrate 5, a chromium reflecting layer 4 formed on the substrate 5, a reflectivity control layer 6 formed on the chromium reflecting layer 4, and a TiO₂ layer 7 formed on the reflectivity control layer 6. The mirror further includes a porous SiO₂ layer 8 on the TiO₂ layer 7, and the thickness of the SiO₂ layer 8 is between 10 and 50 nm so that a photocatalystic function by the TiO₂ layer 7 sufficiently reaches the mirror surface 9.

The reflectivity control layer 6 is made of materials including Al₂O₃, ZrO₃, SnO₂ and SiO₂, which have refractive indexes lower than that of TiO₂, and TiO₂ has a high refractive index and images reflected from the chromium reflecting layer 4 and TiO₂ layer 7 tends to form blurred images.

However, in the case that the thickness of the SiO₂ layer is excessively thick, it is difficult to expose electrons and holes generated from the TiO₂ layer on the surface, thereby resulting in a weak hydrophilic property, and thus the prior art disadvantageously limits the thickness of the uppermost SiO₂ layer to below 15 nm, and coatings are formed on the glass substrate and the chromium plated layer, thereby resulting in a complicate manufacturing process and an inferior crystal structure of the anatase structure TiO₂ layer.

Further, if an oxide layer is formed on the chromium plated layer for controlling the reflectivity, the oxide layer may reduce the adhesive strength with metal.

### DISCLOSURE OF THE INVENTION

The present invention is made to solve the above problems, and therefore it is an object of the present invention to provide a hydrophilic photocatalyst and a process for preparation thereof, in which a titanium dioxide (TiO₂) layer of an amorphous form is coated on a chromium plated layer, and a TiO₂ layer of an anatase structure having good crystallinity is coated on the TiO₂ layer of the amorphous form, thereby obtaining a hydrophilic layer having a good photocatalystic property, and in which a silicon dioxide layer having a good adhesive strength with water is coated on an uppermost layer of a substrate, thereby maintaining a hydrophilic property at night.

In order to achieve the above-mentioned objects, a hydrophilic photocatalyst having a titanium dioxide (TiO₂) layer according to the present invention includes a first TiO₂ layer of an amorphous form coated on a substrate having a chromium plated layer, and the second TiO₂ layer of a pure anatase structure coated on the first TiO₂ layer.

More preferably, the hydrophilic photocatalyst further includes a silicon dioxide (SiO₂) layer coated on the second TiO₂ layer.

The substrate may be selected from the group consisting of glass, metal and ceramic, and the thickness of the first TiO₂ layer is preferably between 5 and 100 nm.

Further, the thickness of the second TiO₂ layer is preferably between 10 and 200 nm, whereas the thickness of the SiO₂ layer is preferably between 5 and 20 nm.

### ADVANTAGEOUS EFFECTS

According to the photocatalyst having TiO₂ layers coated on the chromium substrate of the present invention, a TiO₂ layer is coated on the amorphous TiO₂ layer, which may lead the crystal structure of the TiO₂ layer to a pure anatase structure, and the hydrophilic mirror, which is a kind of the photocatalyst manufactured according to the above-mentioned feature, has an excellent super-hydrophilic property by UV irradiation.

Further, a SiO₂ layer is coated on the anatase structure TiO₂ layer, which may have an excellent hydrophilic property maintained during 18 hours after UV irradiation, and if such a feature is applied to a mirror of an automobile, which is a kind of the photocatalyst, the super-hydrophilic effect prevents water drops from being formed on the mirror surface in the rainy or foggy weather.

### DESCRIPTION OF DRAWINGS

The above and other objects, features and advantages of the present invention will become more apparent from the following detailed description in conjunction with the accompanying drawings, in which:

FIG. 1 is a cross-sectional view of a conventional hydrophilic mirror;

FIG. 2 is a cross-sectional view of a hydrophilic photocatalyst according to an exemplary embodiment of the present invention;

FIG. 3 is an XRD spectrum illustrating crystal structures of titanium dioxide (TiO₂) layers formed on a chromium substrate;

FIG. 4 is photographs taken by a scanning electron microscope (SEM) showing a TiO₂ layer formed on a chromium substrate and a TiO₂ layer formed on a chromium substrate coated with an amorphous TiO₂;

FIG. 5 is photographs taken by an atomic force microscope (AFM) showing the TiO₂ layer formed on the chromium substrate and the TiO₂ layer formed on the chromium substrate coated with the amorphous TiO₂;

FIG. 6 is a graph illustrating changes in a hydrophilic property of the TiO₂ layer formed on the chromium substrate and the TiO₂ layer formed on the chromium substrate coated with the amorphous TiO₂; and

FIG. 7 is a graph illustrating changes in a hydrophilic property of the TiO₂ layer coated with SiO₂ on an uppermost layer of the substrate.

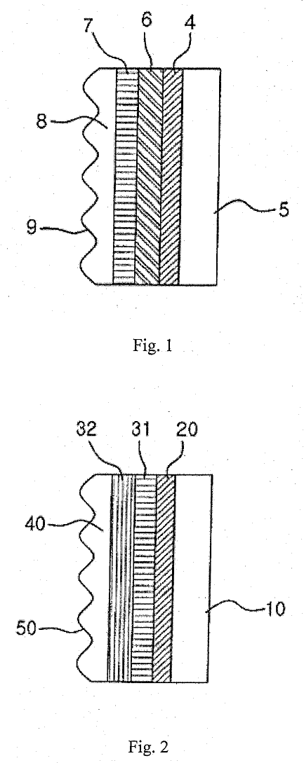

### BEST MODE FOR CARRYING OUT THE INVENTION

Hereinafter, exemplary embodiments of the present invention are described in detail with reference to the accompanying drawings.

FIG. 2 is a cross-sectional view of a hydrophilic photocatalyst according to an exemplary embodiment of the present invention, and a hydrophilic mirror of the photocatalyst according to the present invention uses a commercial mirror coated with chromium as a substrate 10.

As shown in FIG. 2, to manufacture the hydrophilic photocatalyst using a commercial mirror including a chromium plated layer 20 formed on a glass substrate 10 according to the present invention, the chromium plated layer 20 is cleaned in an acetone solution using ultrasonic waves to remove impurities or oxide layers on the chromium plated layer 20.

Then, an amorphous titanium dioxide (TiO₂) layer 31 (hereinafter referred to “first TiO₂ layer”) is coated on the chromium plated layer 20 using a sputtering method.

Preferably, the first TiO₂ layer 31 does not have the rutile or anatase structure, but amorphous form, because the amorphous first TiO₂ layer 31 has a smaller stress remaining in the layer compared with a crystalline form, thereby increasing the adhesive strength between the substrate and the TiO₂ layer.

Further, the thickness of the first TiO₂ layer 31 is preferably between 5 and 100 nm, and the minimum thickness of the first TiO₂ layer 31 is 5 nm, because it is observed that the crystal size of TiO₂ is greater than 5 nm, and therefore the minimum thickness of the first TiO₂ layer 31 is preferably above 5 nm to form a good layer.

The maximum thickness of the first TiO₂ layer 31 is 100 nm and relates to the thickness of a below-mentioned second TiO₂ layer 32 of an anatase structure. That is, to avoid a double image problem of the first TiO₂ layer 31 and second TiO₂ layer 32, the entire thickness of the first TiO₂ layer 31 and second TiO₂ layer 32 is preferably limited to max. 150 nm, and preferably the minimum thickness of the second TiO₂ layer 32 is 50 nm to show a hydrophilic effect, therefore the maximum thickness of the amorphous TiO₂ layer 31 is 100 nm.

Accordingly, for example, if the thickness of the second TiO₂ layer 32 is 80 nm, the thickness of the first TiO₂ layer 31 is equal to or less than 70 nm, and thus the entire thickness of the first TiO₂ layer 31 and second TiO₂ layer 32 are equal to or less than 150 nm.

Next, a TiO₂ layer 32 (hereinafter referred to as a second TiO₂ layer) having a photocatalystic function is coated on the amorphous first TiO₂ layer 31.

The thickness of the second TiO₂ layer 32 having the photocatalystic function is preferably between 10 and 200 nm, and the minimum thickness of the second TiO₂ layer 32 is 10 nm, because it is observed that the crystal size in the second TiO₂ layer is minimum 10 nm, and the maximum thickness of the second TiO₂ layer 32 is 200 nm, because the maximum penetration depth of ultraviolet rays is 200 nm.

In addition, if the thickness of the second TiO₂ layer 32 is greater than 200 nm, the photocatalystic effect does not appear and images separately reflected from the chromium plated layer 20 and first TiO₂ layer 31 are overlapped, thereby resulting in a double image phenomenon, and therefore the thickness of the second TiO₂ layer 32 is preferably between 10 and 200 nm.

Here, the entire thickness of the first TiO₂ layer 31 and second TiO₂ layer 32 is equal to or less than 150 nm in consideration of the thickness of the first TiO₂ layer 31 to avoid the above-mentioned double image problem, and therefore the thickness of the second TiO₂ layer 32 may be adjustable, if necessary.

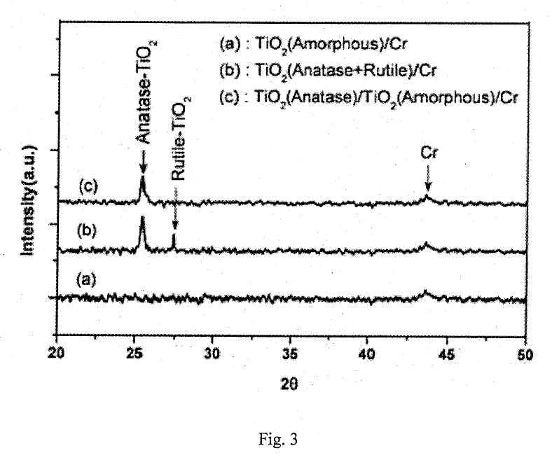

The second TiO₂ layer 32 coated on the first TiO₂ layer 31 has a crystal structure of the anatase structure, and the first TiO₂ layer 31 located below the second TiO₂ layer 32 improves the adhesive strength with the second TiO₂ layer 32 and separates the second TiO₂ layer 32 from the chromium plated layer 20 so that the second TiO₂ layer 32 is formed as a pure anatase structure, and the second TiO₂ layer 32 of the anatase structure is described with reference to FIGS. 3 to 5.

FIG. 3 is an XRD spectrum illustrating crystal structures of TiO₂ layers formed on the chromium substrate coated with the amorphous TiO₂, X ray diffraction is different according to the crystal structures of the amorphous TiO₂ layer and anatase TiO₂ layer. According to FIG. 3, the TiO₂ layer coated on the chromium substrate shows a mixture of the anatase and rutile structures (see (b) of FIG. 3), whereas the TiO₂ layer coated on the substrate having the amorphous TiO₂ layer shows the anatase structure only (see (c) of FIG. 3).

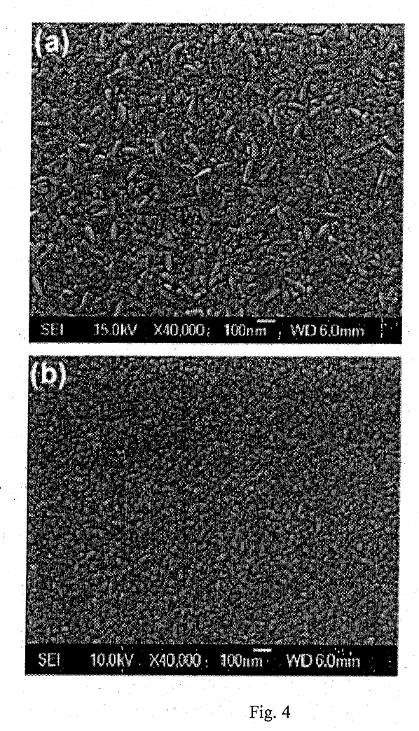

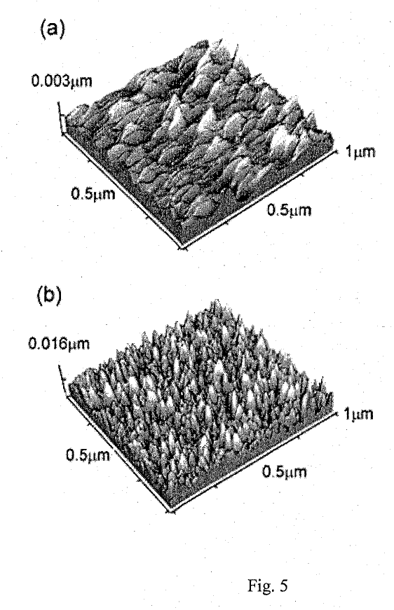

FIG. 4 is an SEM photograph illustrating microscopic structures of the TiO₂ layer formed on the chromium substrate and the TiO₂ layer formed on the chromium substrate coated with the amorphous TiO₂, FIG. 5 is an AFM photograph illustrating the TiO₂ layer formed on the chromium substrate and the TiO₂ layer formed on the chromium substrate coated with the amorphous TiO₂.

According to FIG. 4 (a) and FIG. 5(a), the microstructure of the TiO₂ layer formed on the chromium substrate shows a rutile structure in a plate structure, whereas according to FIG. 4 (b) and FIG. 5(b), the microstructure of the TiO₂ layer formed on the chromium substrate coated with the amorphous TiO₂ shows a very fine anatase structure in a uniform columnar structure between 20 and 30 nm.

As described above, the second TiO₂ layer 32 coated on the amorphous first TiO₂ layer 31 according to the present invention does not have a mixture of the rutile and anatase structures, but a uniform anatase structure between 20 and 30 nm.

Here, because the amorphous layer does not have the crystal structure, the second TiO₂ layer 32 coated on the amorphous first TiO₂ layer 31 eliminates the need of the crystal continuity of surfaces between the first TiO₂ layer 31 and the second TiO₂ layer 32, and thus the anatase structure is easily produced.

A silicon dioxide (SiO₂) layer 40 is formed on the above-mentioned second TiO₂ layer 32 to have the thickness between 5 and 20 nm.

If the thickness of the SiO₂ layer 40 is less than 5 nm, adsorption of water is not achieved, and if the thickness of the SiO₂ layer 40 is greater than 20 nm, the surface of the second TiO₂ layer 32 is completely covered, and thus the hydrophilic property is not maintained, and therefore the thickness of the SiO₂ layer 40 is preferably between 5 and 20 nm.

SiO₂ has a property to adsorb water as well known in the prior art, and SiO₂ is coated on the uppermost layer of the hydrophilic substrate in the present invention to maintain the hydrophilic property of the second TiO₂ layer 32 of the anatase structure. That is, the second TiO₂ layer 32 of the anatase structure generates electrons and holes by UV irradiation, and the generated holes form hydroxyl radicals (OH⁻) on the surface of the TiO₂ layer to have a hydrophilic property, and SiO₂ having a good adsorption of water maintains the hydrophilic property.

### EXAMPLES

Hereinafter, example embodiments of the present invention are described in detail with reference to the accompanying drawings, descriptions are just preferable examples for the purpose of illustration only, and not intended to limit the scope of the invention. For example, it should be understood that the below-mentioned glass substrate may be replaced with a metal substrate or a ceramic substrate, and in this case the glass substrate may be not necessarily applied to a mirror of an automobile.

Referring to FIG. 2, according to the present invention, after a glass substrate 10 having a chromium plated layer 20 is prepared, the chromium plated layer 20 is cleaned using acetone, and an amorphous first titanium dioxide (TiO₂) layer 31 is coated on the chromium plated layer 20 to have the thickness of 10 nm below the temperature of 200° C. to meet the thickness requirement of min. 5 nm n.

Preferably, the coating temperature of the first TiO₂ layer 31 is between 25 and 200° C., and if the temperature of the substrate is higher than 200° C., the TiO₂ layer of the amorphous form is not formed and the anatase and rutile structures are mixed, and thus it is preferred that the maximum coating temperature of the first TiO₂ layer is below 200° C., whereas if the temperature of the substrate is lower than 25° C., the adhesive strength between the first TiO₂ layer and substrate is reduced, and thereby the first TiO₂ layer may be separated from the substrate.

In addition, the second TiO₂ layer 32 of the anatase structure is coated on the first TiO₂ layer 31 to have the thickness of 100 nm to meet the thickness requirement between 10 and 200 nm, and finally, a silicon dioxide (SiO₂) layer 40 is coated on the uppermost layer of the substrate to have the thickness of 10 nm to meet the thickness requirement between 5 and 20 nm, and therefore a mirror having a structure of “anatase TiO₂/amorphous TiO₂/chromium layer/glass substrate” is prepared.

### Experimental Example 1

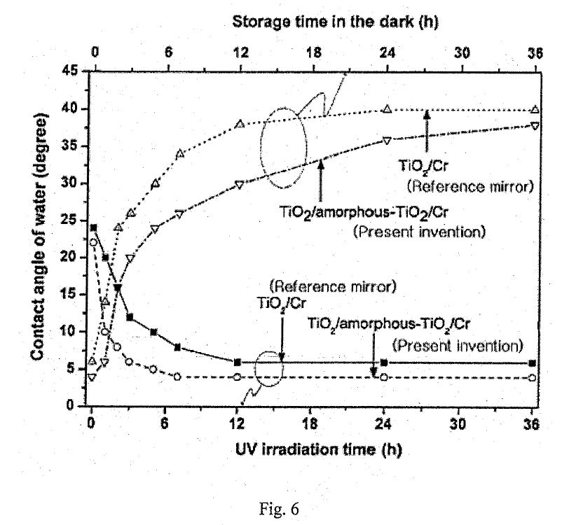

The experimental example 1 is prepared to evaluate the hydrophilic property of the mirror (hereinafter referred to as a hydrophilic mirror) having the structure of “anatase TiO₂/amorphous TiO₂/chromium layer/glass substrate” manufactured according to Example 1. For comparison, after preparing a mirror (hereinafter referred to as a reference mirror) having a structure of “(anatase+rutile) TiO₂/chromium layer/glass substrate” including the rutile structure, water drops are contacted with the surfaces of the hydrophilic mirror and reference mirror, the contact angle between the substrate and water drops is evaluated using ultraviolet (UV) rays, and the test results are shown in FIG. 6.

FIG. 6 is a graph illustrating changes in the hydrophilic property of the TiO₂ layer formed on the chromium substrate as a reference and the TiO₂ layer formed on the chromium substrate having the amorphous TiO₂ coated thereon according to the present invention.

Referring to FIG. 6, when comparing changes in the contact angle by UV irradiation, as the contact angle of the hydrophilic mirror according to the present invention is reduced below 10 degrees within 1 hour after the hydrophilic mirror is irradiated with UV rays, the hydrophilic mirror has a super-hydrophilic property (generally the contact angle below 10 degrees is referred to as ‘super-hydrophilic’)(-∘-graph of FIG. 6), whereas the reference mirror has the same property as the hydrophilic mirror according to the present invention after 5 hours (-▪- graph of FIG. 6).

Further, changes in the contact angles are measured as time passes to evaluate maintenance of the hydrophilic property in the state that UV is removed after 36 hours UV irradiation, and the hydrophilic mirror according to the present invention has a hydrophilic property having a contact angle below 20 degrees during 3 hours (generally the contact angle below 20 degrees is referred to as ‘hydrophilic’) (−7-graph of FIG. 6), whereas the reference mirror has the contact angle greater than 20 degrees after 2 hours (-Δ- graph of FIG. 6).

The hydrophilic mirror according to the present invention has an improved hydrophilic property by UV irradiation and maintains an excellent hydrophilic property.

### Experimental Example 2

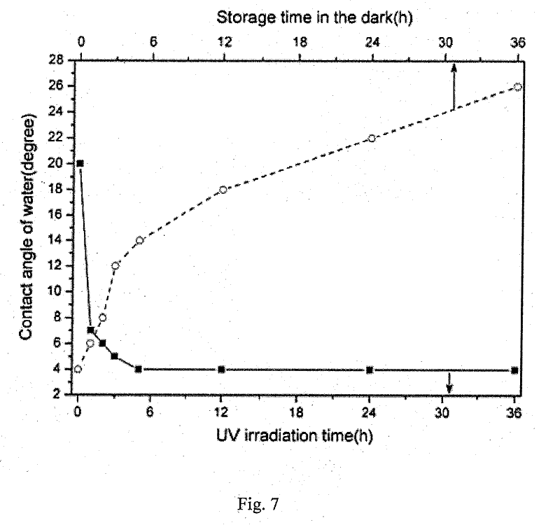

The experimental example 2 is prepared to evaluate the hydrophilic property of a hydrophilic mirror having “SiO₂/anatase TiO₂/amorphous TiO₂/chromium layer/glass substrate” obtained by coating SiO₂ on the uppermost layer of the substrate having the structure of “anatase TiO₂/amorphous TiO₂/chromium layer/glass substrate”. An experiment is made in the same manner as in Experimental example 1, water drops are contacted with the mirror surfaces and the contact angle between the substrate and water drop is evaluated using UV rays, and the test results are shown in FIG. 7.

Referring to FIG. 7, when comparing changes in the contact angle by UV irradiation, as the hydrophilic mirror according to the present invention has a super-hydrophilic property (-▪- graph of FIG. 7) having a contact angle below 7 degrees within 1 hour after UV ray irradiation, and the changes in the contact angle are measured as time passes to evaluate maintenance of the hydrophilic property in the state that UV is removed after 36 hours UV irradiation, the hydrophilic mirror has the hydrophilic property (-∘- graph of FIG. 7) having a contact angle below 20 degrees during 18 hours.

The amorphous TiO₂ layer is coated with the crystal structure of a pure anatase TiO₂ layer having the hydrophilic property by a photocatalyst effect, and SiO₂ is coated on the anatase TiO₂ layer so as to maintain the hydrophilic property, and thus the resultant hydrophilic mirror meets the requirement suitable for commercialization. That is, for commercialization of the hydrophilic mirror, the hydrophilic property should be maintained during 12 hours or more from late in the afternoon having a low ultraviolet index to early in the morning, and the hydrophilic mirror according to the present invention sufficiently achieves the above-mentioned condition for commercialization.

Although exemplary embodiments of the present invention have been described in detail hereinabove, it should be understood that many variations and modifications of the basic inventive concept herein described, which may appear to those skilled in the art, will still fall within the spirit and scope of the exemplary embodiments of the present invention as defined in the appended claims.

### INDUSTRIAL APPLICABILITY

The photocatalyst according to the present invention may be applied to mirrors of automobiles and products other than the automobiles, for example building materials, and the substrate of the hydrophilic mirror may be made from glass, metal or ceramic such as tile.

1. A hydrophilic photocatalyst having a titanium dioxide (TiO₂) layer, the hydrophilic photocatalyst comprising:
a first TiO₂ layer of an amorphous form coated on a substrate having a chromium plated layer; and
a second TiO₂ layer of a pure anatase structure coated on the first TiO₂ layer.

2. The hydrophilic photocatalyst according to claim 1, wherein a silicon dioxide (SiO₂) layer is coated on the second TiO₂ layer.

3. The hydrophilic photocatalyst according to claim 1, wherein the substrate is selected from the group consisting of glass, metal and ceramic.

4-8. (canceled)

9. The hydrophilic photocatalyst according to claim 2, wherein the substrate is selected from the group consisting of glass, metal and ceramic.
